(19) United States
(12) Patent Application Publication
(10) Pub. No.: US 2026/0213779 A1
(43) Pub. Date: Jul. 23, 2026

(54) IMPROVED N-PLEXER

(71) Applicant: Forefront RF Ltd, Cambridge (GB)

(72) Inventors: Leo Laughlin, Cambridge (GB); Michael Guess, Middlesbrough (GB)

(21) Appl. No.: 19/139,700

(22) PCT Filed: Dec. 14, 2023
(86) PCT No.: PCT/EP2023/085949

§ 371 Date: Jun. 16, 2025

(30) Foreign Application Priority Data
Dec. 16, 2022 (GB) 2219070.6

(51) Int. Cl. H04B 1/04; H04B 1/00; H04B 1/18; H04B 1/525

(52) U.S. Cl. CPC H04B 1/0458; H04B 1/0057; H04B 1/0475; H04B 1/18; H04B 1/525; H04B 2001/0408

(57) ABSTRACT

There is disclosed a circuit for transmitting a transmit signal at a transmit frequency and for receiving a signal at a receive frequency, using a common antenna, comprising: a transmit filter connected between a transmit port and an antenna port; a receive filter connected between a receive port and the antenna port; a cancellation circuit connected between the transmit port and the receive port to cancel self-interference between the transmit and receive ports; and a control circuit for modifying the transmit and/or receive filters to improve impedance matching between the antenna port and the transmit filter output and/or the receive port filter input.

### FIELD OF THE INVENTION

The present invention is related to methods and apparatus for suppressing interference between a receive path and a transmit path in an n-plexer, such as a duplexer. The invention is particularly but not exclusively concerned with the implementation of an n-plexer in the front end of a radio frequency (RF) device, such as a mobile RF device.

### BACKGROUND TO THE INVENTION

A common feature of wireless communication equipment is the ability to transmit and receive wireless signals at the same time, known as full-duplex operation, for example using a frequency division duplex (FDD) scheme.

Simultaneously transmitting and receiving wireless signals leads to a problem wherein the relatively high-powered signal transmitted from the transmitter is coupled to the receiver where it can obscure a relatively low-powered signal which is desired to be received. The signal component at the receiver due to the devices own transmission is known as self-interference. A duplexer is typically required to suppress the self-interference at or before the receiver in order to enable successful reception in the presence of a transmission.

It is an aim of the invention to provide an improved duplexer, or more generally an improved n-plexer or frequency division transmit and receive combiner.

### STATEMENT OF THE INVENTION

Ideally maximum power is transferred between a power amplifier and an antenna on the transmit side, and between an antenna and a low noise amplifier on the receive side by achieving antenna impedance matching between the antenna and the circuits to which it connects. In multiplexer applications achieving such impedance matching with the antenna, the power amplifier, and the low noise amplifier is achieved.

In the following statements and description reference to a ‘port’ is illustrative of a location at the transmitter (‘transmit port’), receiver (‘receive port’) or antenna (‘antenna port’) , and is not limited to a fixed position.

There is provided a circuit for transmitting a transmit signal at a transmit frequency and for receiving a signal at a receive frequency, using a common antenna, comprising: a transmit filter connected between a transmit port and an antenna port; a receive filter connected between a receive port and the antenna port; a cancellation circuit connected between the transmit port and the receive port to cancel self-interference between the transmit and receive ports; and a control circuit for modifying the transmit and/or receive filters to improve impedance matching between the antenna port and the transmit filter output and/or the receive port filter input.

More generally the circuit provides a transmit filter for filtering a transmit signal delivered to an antenna from a transmitter; a receive filter for filtering a receiver signal delivered from the antenna to a receiver; a cancellation circuit connected between the transmitter and the receiver to cancel self-interference between the transmitter and receiver; and a control circuit for modifying the transmit and/or receive filters to improve impedance matching between the antenna and the transmit filter output and/or the receive filter input.

The antenna port may be for connection to the common antenna. The transmit port may be for connection to the output of a power amplifier. The receive port may be for connection to the input of a low noise amplifier.

The control circuit may be connected to measure a signal at the antenna port, and modify the transmit filter and/or the receive filter to improve the impedance matching in dependence on the signal measured at the antenna port.

The control circuit may be connected to measure a signal at the receive port, and modify the transmit filter and/or the receive filter to improve impedance matching in dependence on the signal measured at the receiver port.

The control circuit may be further configured to modify the cancellation circuit to improve self-interference cancellation between the transmit and receive ports. The control circuit may be configured to modify the cancellation circuit in dependence on a signal measured at the antenna port. The control circuit may be configured to modify the cancellation circuit in dependence on a signal measured at the receive port. The control circuit may be further configured to modify the transmit and/or receive filter to further improve self-interference cancellation between the transmit and receive ports.

The control circuit may be configured to measure only the unwanted power at the receive port. The unwanted power may be the power due to self-interference between the transmit and receive ports.

The circuit may be further configured in dependence on the measured signal at the receive port to control: the transmit and/or receive filters to improve impedance matching between the antenna port and each of the transmit and/or receive ports; and the cancellation circuit to improve self-interference cancellation between the transmit and receive ports. The control circuit may be further configured in dependence on that measured power at the receive port to control: the transmit and/or receive filters to improve self-interference cancellation between the transmit and receive ports.

There is provided a method for transmitting a signal at a transmit frequency and for receiving a signal at a receive frequency, using a common antenna, the method comprising: filtering a transmit signal received at a transmit port for delivery to an antenna port; filtering a receive signal received at the antenna port for delivery to a receive port; applying cancellation to cancel self-interference between the transmit and receive ports; and modifying the filtering of the transmit and/or receive signal to improve impedance matching with the antenna port.

More generally the method comprises: filtering a transmitter signal for delivery to an antenna; filtering a signal received at the antenna for delivery to a receiver; applying cancellation to cancel self-interference between the transmitter and the receiver; and modifying the filtering of the transmitter and/or receiver to improve impedance matching with the antenna.

The method may further comprise measuring a signal at the antenna port, and modifying the transmit and/or the receive filtering to improve the impedance matching in dependence on the signal measured at the antenna port.

The method may further comprise measuring a signal at the receive port, and modifying the transmit and/or the receive filtering to improve impedance matching in dependence on the signal measured at the receiver port.

The method may further comprise modifying the cancellation circuit to improve self-interference cancellation between the transmit and receive ports.

There is provided a circuit for transmitting and receiving using a common antenna, comprising: an adjustable antenna coupling network connecting a transmitter, an antenna, and a receiver; a cancellation circuit connected between the transmitter and the receiver, configured to at least partially cancel self-interference; and a controller configured to modify the antenna coupling network in dependence on a self-interference signal measured at the receiver to improve impedance matching of the antenna.

The circuit may further comprises a circuit to measure the self-interference signal at the receiver. The self-interference signal may be measured at a receive port. The self-interference signal may be measured at an input of a low noise amplifier connected to a receive port.

The cancellation circuit may be an adjustable cancellation circuit. The adjustable cancellation circuit may be adjusted to increase the level of self-interference cancellation.

The antenna coupling network may include an antenna impedance tuner connected to the antenna, the controller being configured to modify the antenna impedance tuner to match antenna impedance.

The antenna coupling network may further include a transmit filter and/or a receive filter, the antenna impedance tuner matching the antenna impedance to the output of the transmit filter and/or the input of the receive filter.

The antenna coupling network may further comprise a circulator connected between the transmitter, the receiver, and the antenna, the controller being configured to modify the antenna impedance tuner to match the antenna impedance to the circulator impedance at the transmit and receive frequencies.

The antenna impedance tuner may be connected between the antenna and the transmit and/or receive filters. The antenna impedance tuner may be connected between the antenna port and electrical ground.

The controller may be further configured to adjust the output impedance of the transmit filter and/or the input impedance of the receive filter to match the antenna impedance.

The cancellation circuit may include a balancing load, and the impedance presented by the antenna is modified to match the impedance presented by the balancing load.

There is provided a method for transmitting and receiving using a common antenna, comprising: a connecting a transmit port, an antenna port, and a receive port; at least partially cancel received self-interference between the transmitter and the receiver; measuring a self-interference signal at the receiver; and modifying the antenna coupling network to improve impedance matching of the antenna in dependence on the measured self-interference signal.

### BRIEF DESCRIPTION OF THE FIGURES

The invention is now described with reference to the accompanying drawings, in which:

FIG. 1 illustrates an exemplary duplexer in a first aspect;

FIG. 2 illustrates an exemplary filter;

FIG. 3 illustrates an exemplary duplexer in a second aspect;

FIGS. 4(a) to 4(c) illustrate example antenna coupling networks in the second aspect;

FIG. 5 illustrates an example canceller with the antenna coupling network of FIG. 4(b);

FIG. 6 illustrates a further exemplary duplexer in the second aspect;

FIG. 7 illustrates an example canceller with the further exemplary duplexer of FIG. 6; and

FIG. 8 illustrates an exemplary multiplexer in the first or second aspects.

### DESCRIPTION OF PREFERRED EMBODIMENTS

The invention is now described by way of reference to examples and embodiments.

Examples are presented of a duplexer, but in general the described techniques are applicable to an n-plexer. The simplest implementation of an n-plexer is a duplexer. In general an n-plexer provides for a first plurality of transmit frequencies and a second plurality of received frequencies. The first and second plurality may be the same value or may be different values. An example of a quadplexer is described herein to illustrate how the techniques described may be extended beyond a duplexer arrangement.

An exemplary, but non-limiting, implementation of the apparatus described is in the front end of an RF device, such as a mobile RF device, such as a mobile phone.

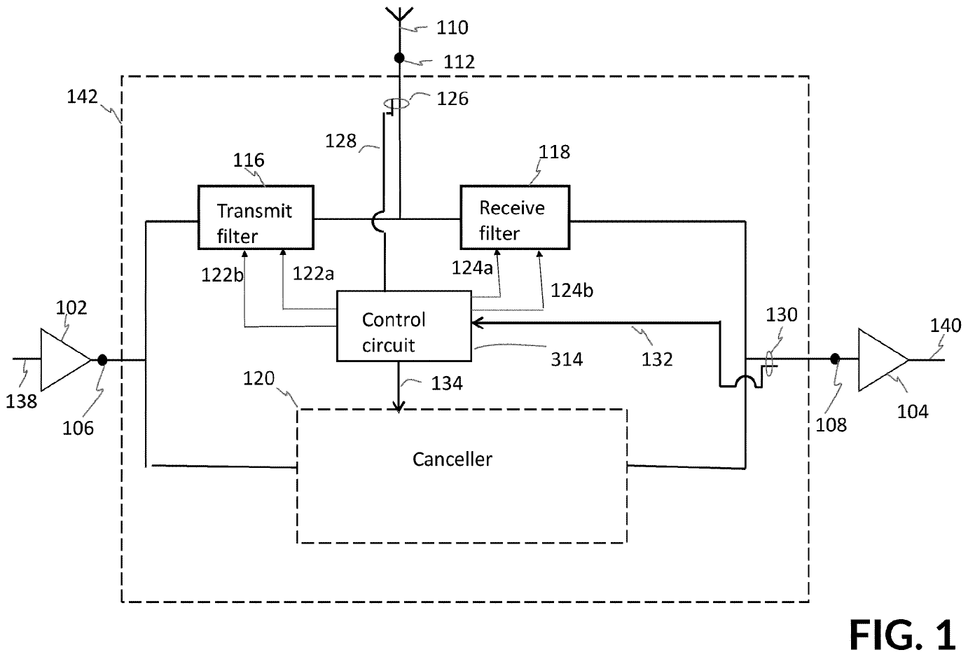

With reference to FIG. 1 there is shown an exemplary duplexer 142 in the front end of an RF device incorporating a first aspect.

The exemplary duplexer 142 has a transmit port 106, a receive port 108, and an antenna port 112. The transmit port 106 receives an output from a power amplifier 102, which receives a signal to be transmitted on line 138. A low noise amplifier (LNA) 104 receives a received signal at the receive port and outputs the received signal on line 140. The antenna port 112 is connected to a common antenna 110, which is used for transmitting and receiving signals.

The exemplary duplexer 142 includes a transmit filter 116 connected between the transmit port 106 and the antenna port 112. The transmit filter 116 is preferably an adjustable filter, adjusted to the frequency of the transmit signal, to pass the transmit signal received at the transmit port 106 to the antenna port 112 for transmission of the transmit signal with the antenna 110.

The exemplary duplexer includes a receive filter 118 connected between the receive port 108 and the antenna port 112. The receive filter 118 is preferably an adjustable filter, adjusted to the frequency of the received signal, to pass the signal received at the antenna 110 to the receive port 108.

A canceller circuit 120 is connected in a cancellation path between the transmit port 106 and the receive port 108 in order to cancel self-interference in the duplexer, i.e. the interference present in the received signal of the duplexer which is due to injection of signals from the transmit side of the duplexer. The implementation of the canceller circuit 120 is outside the scope of this disclosure.

A control circuit 114 provides control signal on lines 122a and 122b to adjust the transmit filter 116, and control signals on lines 124a and 124b to adjust the receive filter 118.

The control signals on lines 122a control the frequencies and/or bandwidths of one of more passbands and/or one or more stopbands of the transmit filter 116. The control signals on lines 122b control the input impedance and/or output impedance of the transmit filter 116 in accordance with the first aspect as discussed further below.

The control signals on lines 124a control the frequencies and/or bandwidths of one of more passbands and/or one or more stopbands of the receive filter 118. The control signals on lines 124b control the input impedance and/or output impedance of the receive filter 118 in accordance with the first aspect as discussed further below.

The control circuit 114 further provides control signals on lines 134 to the canceller circuit to provide predetermined configuration settings to the canceller and/or adjust the canceller settings during operation.

Self-interference is the interference present in the received signal of the duplexer which is due to injection of signals from the transmit side of the duplexer. A self-interference transfer function describes the linear frequency response of the self-interference path between the transmit and receive sides.

The self-interference transfer function (or leakage transfer function) is the aggregate transfer function of the cascade of components in the self-interference path, i.e. from the PA 102 output, via the transmit filter 116, via the antenna 110 connected in parallel with the receiver filter, via the receive filter 118, to the LNA 104 input. The self-interference transfer function is determined by the characteristics of these individual circuits and the interactions between them. The self-interference transfer function therefore depends-in part-on the impedance of the antenna.

The purpose of the canceller circuit 120 is to produce a signal which is equal in amplitude and opposite in phase compared to the self-interference or leakage signal at the receive port 108. It does this by configuring its circuits to produce a canceller transfer function which is equal in amplitude and opposite in phase to the self-interference transfer function (or leakage transfer function) over the frequency ranges of interest, i.e. transmit frequency band(s) and receive frequency band(s).

In the duplexer 142 the canceller circuit 120 and the duplexer transmission input (to transmit filter 116) are driven by the same signal (the transmit signal at the transmit port 106). Therefore when the canceller transfer function and the self-interference transfer function are in anti-phase, the self-interference will desirably cancel.

The level of cancellation is determined by how closely the canceller transfer function can be configured to be the anti-phase of the self-interference transfer function. To achieve self-interference cancellation at a single frequency point requires only that the canceller transfer function is the anti-phase of the self-interference transfer function at said single frequency point. To achieve cancellation over a frequency band of interest requires that the canceller transfer function is the anti-phase of the self-interference transfer function over said frequency band of interest.

The canceller circuit 120 may be constructed from passive components which are arranged in a network such as to be able to produce a configurable frequency response in operation. A problem with configuring a canceller circuit is that it is not possible to know at the design stage certain factors which will cause self-interference.

A major unknown factor is the antenna impedance, which may be unknown to the designer of the RF front-end beyond a nominal impedance specification, for example 50 Ω. However the antenna impedance may change during operation due to environmental interactions which are unpredictable at the design stage.

The impedance of the antenna depends on the local environment around the antenna. The local environment influences the effective impedance seen at the antenna port due to electromagnetic interactions between the antenna and objects local environment. This is especially relevant in a mobile phone where the phone may be located very close by to external items, such as a user's hand or head. The antenna impedance is influenced by the operating environment, which will affect the self-interference transfer function.

Thus in general a canceller circuit, such as the canceller circuit 120, is designed to be generic and able to adapt to a range of likely self-interference transfer functions which may be encountered during operation. Where the canceller is not able adapt to provide the canceller transfer function needed to perfectly cancel the self-interference over one or more frequency bands of interest, this limits the level of cancellation which can be achieved over that band or bands, and self-interference is present at the receiver after cancellation is applied.

The self-interference transfer function depends-in part-on the impedance of the antenna, given that self-interference arises in a path which includes the antenna. The coupling of self-interference from the output of the transmit port to the receive port depends on the characteristics and input/output impedances of the filters 116,118, as well as the impedance of the antenna 110.

Adjusting the output and input impedance matching of the transmit and receive filters 116,118 may be beneficial for improving power transmission through each filter at frequencies in the passband(s) of the filter. This is beneficial for maximising transfer between the transmit port and the antenna for improved transmit efficiency, and for maximising power transfer between the antenna and the receiver port for improved receiver sensitivity. Maximising power transfer in to the antenna 110 may also reduce self-interference.

Additionally, the one or more of the filters 116,118 may be adjusted in a manner which modifies the coupling of self-interference to provide a modified self-interference transfer function which the canceller transfer function may be better adapted to provide cancellation for. The filters 116, 118 may be adjusted to modify the self-interference coupling. This may improve self-interference cancellation.

In accordance with the first aspect the output impedance of the transmit filter is adjusted to improve impedance matching between the transmit filter and the antenna in one or more transmit frequency bands, and/or the input impedance of the receive filter is adjusted to improve impedance matching between the receive filter and the antenna in one or more receive frequency bands.

In order to achieve these benefits, it is necessary to provide the transmit and/or receiver filters 116,118 as variable filters, and configure the control circuit 114 to control these variable filters.

Whilst antennas typically exhibit a fixed resonant frequency or frequencies and a limited bandwidth over which they operate efficiently and sufficiently well over their operating bandwidth, in accordance with this first aspect the transmit and receive filters can be tuned to extend the range of possible operating frequencies of the antenna by improving the impedance match with the antenna at frequencies that would otherwise be poor. The transmit and receive filters can configure the impedances presented to the antenna (the output and input impedances of the transmit and receive filters respectively). The frequency range(s) of acceptable impedance matching can be adjusted by tuning the filters 116 and/or 118, improving the effective antenna efficiency at a particular frequency or frequencies, for example a transmit and/or receive frequency band or bands.

In this manner in accordance with the first aspect the filter circuits 116 and/or 118 not only provide for the filtering of signals, but also act as tuneable impedance matching networks. This enables the antenna to be operated efficiently at frequencies beyond its un-tuned operating frequency range or ranges.

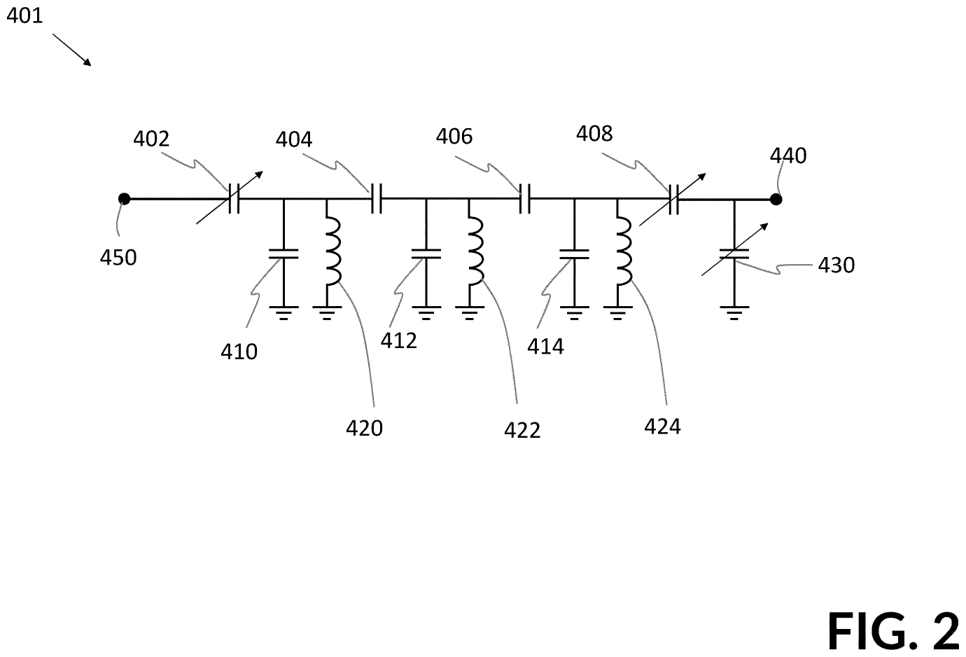

With reference to FIG. 2 there is illustrated an example implementation of a filter, which is configured for adjustable input and/or output impedance. Either the transmit or receiver filters 116, 118 may be implemented in accordance with the example filter of FIG. 2 accordance with the first aspect.

The filter 401 of FIG. 2 has an first terminal 450 and an second terminal 440. A variable capacitor 402 has a first terminal connected to the input terminal 450, a capacitor 404 has a first terminal connected to a second terminal of the capacitor 402, a capacitor 406 has a first terminal connected to a second terminal of the capacitor 404, and a variable capacitor 408 has a first terminal connected to a second terminal of the capacitor 406 and a second terminal connected to the output port 440. A capacitor 410 and inductor 420 are connected in parallel between the junction of the terminals of the capacitors 402 and 404 and electrical ground. A capacitor 412 and inductor 422 are connected in parallel between the junction of the terminals of the capacitors 404 and 406 and electrical ground. A capacitor 414 and inductor 424 are connected in parallel between the junction of the terminals of the capacitors 406 and 408 and electrical ground. A variable capacitor 430 is connected between terminal 440 and electrical ground.

Impedance matching at terminal 440 can be adjusted by tuning variable capacitors 408 and/or 430. Variable capacitor 430 may optionally be omitted.

Impedance matching at terminal 450 can be adjusted by tuning variable capacitor 402. A shunt capacitor (a variable capacitor connected to electrical ground) may be optionally connected at terminal 450.

Optionally all other capacitors shown may be tuneable, to provide for tunability of the filter centre frequency and/or bandwidth as well as impedance matching.

FIG. 2 illustrates an example filter which may be configured to provide for impedance matching in accordance with the first aspect. The first aspect is not limited to this exemplary implementation, and the transmit and/or receiver filters 116 and/or 118 may be implemented differently than FIG. 2 and be configured to provide impedance matching to the antenna, at ports connected to the antenna.

Measurements may be made at the antenna port 112 as denoted by coupling 126, and/or at the receive port as denoted by coupling 130. These measurements are provided as inputs to the control circuit 114 on lines 128 and 132 respectively.

The measurements at the receive port are representative. In general measurements are made at the receiver at a location at or after cancellation has been applied. For example a signal may be measured after the LNA 104. The purpose of this measurement is to obtain a signal indicative of the self-interference after cancellation is applied. A measurement of self-interference may be analogue and/or digital, and may be at radio frequencies and/or baseband frequencies.

The amplitude and/or phase of one or more signals may be measured at the receive port or antenna port.

A directional coupler may be used as coupling 126 at the antenna port. This may enable the forward and reflected signals at the antenna port to be measured, from which the antenna impedance can be estimated. A complex antenna impedance may be estimated.

Reflected power may be measured at the antenna port, from which the antenna return loss can be estimated.

The power at the receive port 108 may be measured. Where power is measured at the receive port, it may be the unwanted power of the self-interference signal that is measured. Other properties of the self-interference signal may be measured, including the amplitude and/or phase of the voltage and/or current of the self-interference signal.

Signals may be measured at one or more discrete frequency points and/or over one or more frequency bands, for example a transmit and/or receive frequency band.

The control circuit 114 may control the transmit filter 116 and/or the receive filter 118 by antenna impedance matching in dependence on one or more signals measured at the antenna port and/or one or more signals measured at the receive port.

The control circuit 114 may also control the canceller circuit 120 in dependence on one or more signal measured at the receive port.

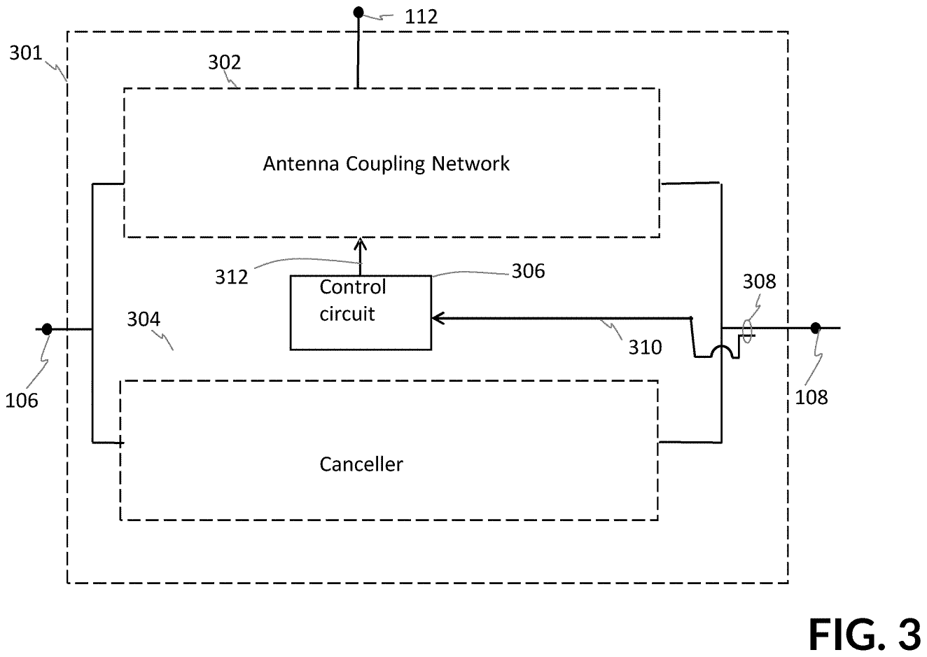

With reference to FIG. 3 there is illustrated an arrangement of a duplexer 301 in accordance with a second aspect.

The duplexer includes the antenna port 112, the transmit port 106, and the receive port 108 for respective connection to the antenna 110, the PA 102 and the LNA 104 as per FIG. 1. An antenna coupling network 302 couples the transmit and receive ports to the antenna port. A canceller circuit 304 is connected between the transmit port and the receive port.

In this second aspect a self-interference signal at the receive port 108 is measured by a coupler 308, and this measurement is used by a control circuit 306 to generate control signals 302 to control antenna impedance matching in the antenna coupling network 302.

The location of the measurement point at the receive port is exemplary. As set out in relation to the first aspect, the purpose is to measure an indication of the self-interference, and therefore to measure a signal at the receiver at a point after the cancellation has been applied.

The canceller circuit 304 is provided to cancel self-interference at the receive port 108. In practice, the canceller circuit does not achieve full cancellation of the self-interference at the receive port, and an amount of self-interference will be measured by the control circuit in the presence of the canceller. The control circuit then adjusts the antenna impedance matching in the antenna coupling network in order to reduce the self-interference further. For example, the control circuit may iteratively increase or decrease one or more antenna impedance matching parameters in order to lower the value of self-interference. This tuning based on the self-interference value improves impedance matching.

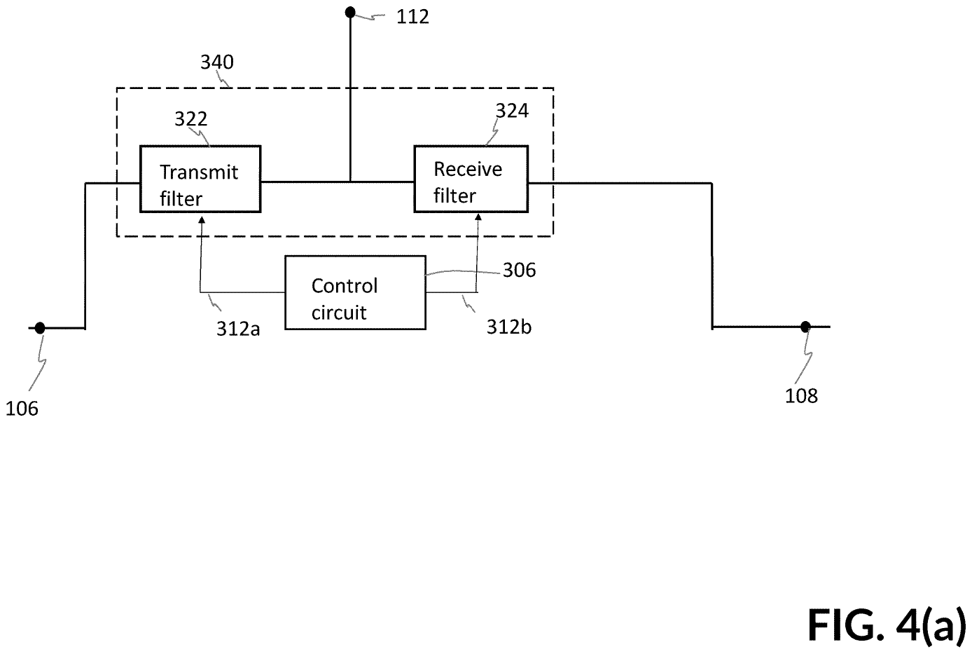

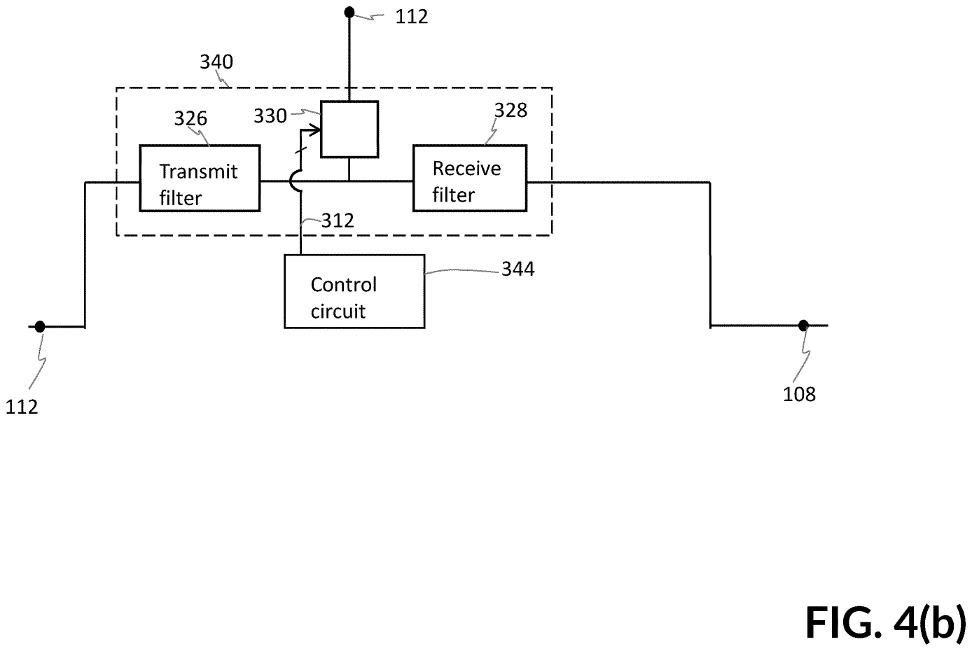

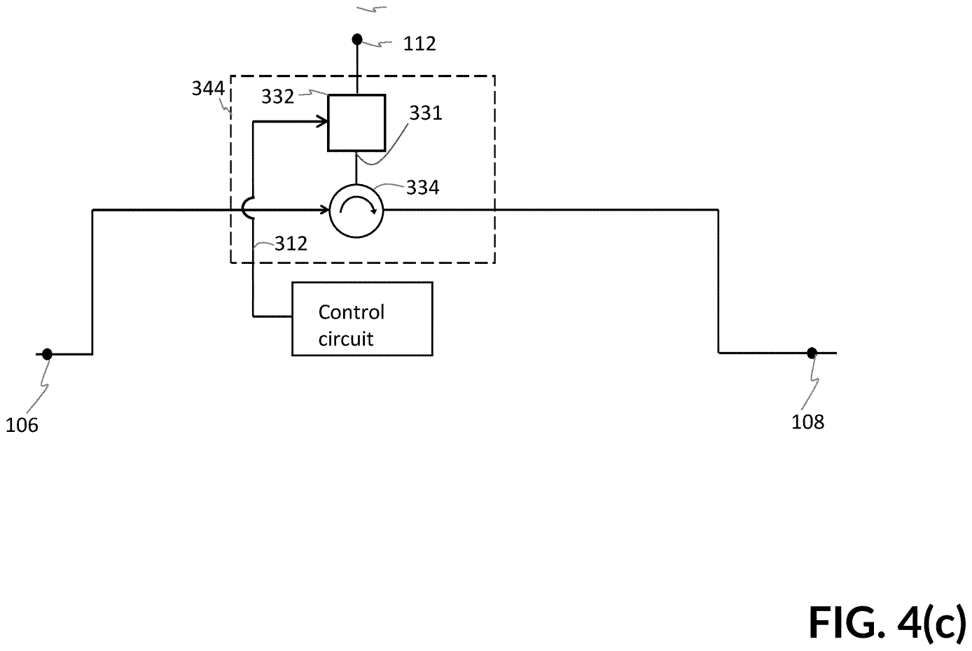

With reference to FIGS. 4(a) to 4(c) there is shown antenna impedance matching control for three example implementations of an antenna coupling network. The canceller circuit is not shown for ease of illustration, but is required as shown in FIG. 3.

In each example the control circuit 306 receives the signal 310 measured at the receive port 108 (or more generally, measures a signal received at that port, which may be a self-interference signal).

As shown in FIG. 4(a), an example antenna coupling network 340 comprises a transmit filter 322 connected between the transmit port 106 and the antenna port 112 and a receive filter 324 connected between the receive port 108 and the antenna port 112.

The control circuit 306 outputs a first control signal 312a to the transmit filter 322, and a second control signal 312b to the receive filter 324.

In this example antenna impedance matching is adjusted by varying the transmit and receive filters as described in the first aspect.

As shown in FIG. 4(b), an example antenna coupling network 342 comprises a transmit filter 326 connected at one end to the transmit port 106, a receive filter 328 connected at one end to the receive port 108, and an antenna impedance tuner 330 connected at one end to the antenna port 112. The other ends of each of the transmit filter 325, the receiver filter 328, and the antenna impedance tuner 330 are connected together.

The control circuit 306 outputs control signals 312 to the antenna impedance tuner 330 to adjust antenna impedance matching between the transmit filter and the antenna, and the receive filter and the antenna, to improve the impedance match between the antenna connected at the antenna port and the transmit and receive filters.

As shown in FIG. 4(c), an example antenna coupling network 344 comprises a circulator 334 and an antenna impedance tuner 332. The circulator 334 is connected between the transmit port 106 and the receive port 108. The antenna impedance tuner 332 is connected between the antenna port 112 and the circulator 334.

The control circuit 306 outputs control signals 312 to the antenna impedance tuner 330 to adjust antenna impedance matching between the circulator 334 and the antenna at the transmit and receive frequencies.

In each arrangement shown in FIGS. 4(a), 4(b), and 4(c) the antenna impedance matching is varied in dependence on the measured self-interference at the receive port (or more generally at the receiver).

Alternative antenna coupling networks may be implemented, beyond the three examples of FIGS. 4(a) to 4(c). For example, the antenna coupling network may comprise one or more filters, duplexers, quad-plexers, hexa-plexers, octo-plexers, multiplexers, circulators, directional couplers, or combinations thereof.

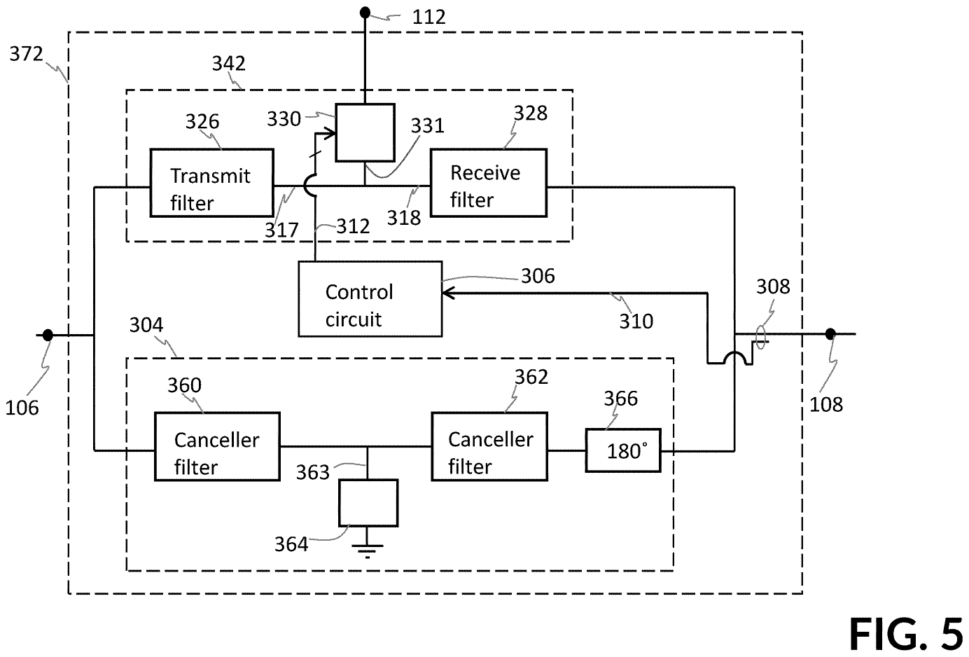

With reference to FIG. 5, there is described an example implementation of the duplexer using the antenna coupling network of FIG. 4(b) including an example implementation of a canceller 304. Like reference numerals are used to denote elements from earlier figures.

In this example the canceller 304 is implemented with a first cancellation filter 360 having one terminal connected to the transmit port 106, a second cancellation filter 362 having one terminal connected to a second terminal of the first cancellation filter 360, a balancing impedance 364 connected between electrical ground and common terminals of the first and second cancelation filters, and a 180° phase shifter 366 connected between a second terminal of the second cancellation filter 362 and the receive port 108.

The output impedance of transmit filter 326 and the input impedance of receive filter 328 are preferably impedance matched to the antenna impedance tuner 330 in the respective passbands of the transmit and receive filters 326, 328 by the antenna impedance tuner 330. These impedances (the output impedance of transmit filter 326 at terminal 317 in the passband of transmit filter 326, the input impedance of receive filter 318 at terminal 319 in the passband of receive filter 318, the input impedance of the antenna impedance tuner 330 at terminal 334 in the passband of transmit filter 326, and the output impedance of the antenna impedance tuner 330 at terminal 334 in the passband of receive filter 328) may all be the same nominal impedance, for example 502. The antenna impedance tuner 330 provides adjustable impedance matching between terminal 331 and the antenna port 112.

The antenna impedance tuner 330 is controllable to variably transform the impedance presented by the antenna at the antenna port 112 into another impedance (such as a nominal impedance 502) presented to the filters 316 and 318 at terminal 331.

The antenna impedance tuner 330 may comprise a tuneable matching network of fixed and adjustable components, for example one or more fixed and/or tuneable capacitors and/or inductors. The implementation of the antenna impedance tuner is outside the scope of this disclosure.

In FIG. 5 the antenna tuner 330 is connected in series in the path between the filters 326,328 and the antenna. In alternative arrangements, an antenna impedance tuner may be connected in parallel at the terminal 112 (between the terminal 112 and electrical ground) to also control the impedance matching between the antenna and the filters 326,328.

The canceller 304 receives a transmit signal from the transmit port 106 and outputs a cancellation signal at the receive port 108. As described above with reference to the first aspect, the level of cancellation depends on the correspondence between a self-interference transfer function and a canceller transfer function. In the example of the duplexer of FIG. 5, cancellation requires that the self-interference transfer function via transmit filter 326, via the connection to terminal 331 of the antenna impedance tuner, and via the receive filter 328, closely matches the cancellation transfer function of the path via cancellation filter 360, via the connection to terminal 363 of the balancing impedance 364, and via the cancellation filter 362.

Thus, among other factors, the level of cancellation depends upon the impedance at the terminal 331 of the antenna impedance tuner 330. This dependence can be exploited to tune the impedance matching of an antenna based on measurements of self-interference made at a receiver in accordance with this second aspect.

In the example duplexer of FIG. 5, the canceller filters 360 and 362 may be of identical design to the transmit and receive filters 326 and 328. Preferably, the canceller filter 360 has the same response as the receive filter 328, and the canceller filter 326 has the same response as the transmit filter 326. Preferably, the impedance presented by the balancing impedance 364 at terminal 363 is the same as the impedance presented by the antenna impedance tuner at terminal 331. These relationships between the filters 326, 328, 360, 362 and between the impedances of the antenna impedance tuner 330 at terminal 331 and the balancing impedance 364 at terminal 363, provide a symmetry in the circuit which results in cancellation of self-interference at the receive port 308. Where these relationships are included in a design, the cascaded transfer function through transmit filter 326, via connection to terminal 331, and through receive filter 328, is the same as the cascaded transfer function through canceller filter 360, via the connection to the balancing impedance 364 at terminal 636, and through canceller filter 362. Thus, when considering the inclusion of the 180° phase shifter 366, which inverts the phase, the symmetry in the circuit results in the cancellation transfer function through the canceller 304 being the inverse of the self-interference transfer function through the antenna coupling network 342, thereby resulting in self-interference cancellation. Thus, in this example, self-interference cancellation is achieved by matching the impedance presented by the antenna impedance tuner at terminal 331 to the impedance presented by the balancing network 364 at terminal 363.

The antenna impedance tuner 330 is adjusted by the control circuit 306 to control the impedance presented at the terminal 331, which may adjust the level of self-interference cancellation being achieved in the circuit. The antenna impedance tuner 330 is adjusted to increase self-interference cancellation. Such adjustment is made in dependence on a signal measured at the receiver, e.g. at coupler 308.

The balancing impedance may be a nominal impedance, for example 502. This may be the same impedance as the nominal design impedance of the antenna 110.

Adjusting the impedance presented at terminal 331 to increase self-interference cancellation has the effect of adjusting the impedance value 330 towards the value of the impedance at terminal 363 provided by the balancing impedance 364. Where the balancing impedance value has been selected appropriately, this also results in improved impedance matching of the antenna. For example, if the filters 326 and 328 have been designed to match with 502 in their respective passbands, and the balancing impedance 328 is selected to be 502, then adjusting the antenna tuner to increase the level of self-interference cancellation will move the impedance at terminal 331 towards 502, thereby providing improved matching between the filters 326, 328 and the antenna 110.

Thus the level of self-interference cancellation and the quality of impedance matching at the antenna becomes co-dependent, such that increasing the level of self-interference cancellation has the by-product of improving the impedance matching between the antenna and the transmit and receive paths (and vice-versa).

The duplexer 342 thus provides an improved circuit for adjustable antenna impedance matching and self-interference cancellation. This improvement does not require a signal to be measured at the antenna port, which is beneficial in reducing the number of components and in reducing losses between the antenna and the transmitter and/or receiver.

In an example implementation, the duplexer is controlled as follows:
i) The canceller is set to provide cancellation at a given transmit and receive frequency of operation. This may be a predetermined setting, and may be set prior to operation.
ii) In operation, the self-interference is measured in the received signal.
iii) In dependence on the measured self-interference, the antenna impedance matching is adjusted to further reduce the measured self-interference.

In the example of FIG. 5, self-interference will be reduced when the value of the antenna impedance is adjusted towards the value of the balancing impedance, to improve antenna impedance matching.

FIG. 5 illustrates one example of a canceller design to achieve co-dependence between self-interference cancellation and antenna impedance matching. Such co-dependence does not depend on implementing a canceller or antenna coupling network as shown in the example of FIG. 5. Any antenna network coupling arrangement may be used which allows for antenna impedance matching to be adjusted, non-limiting examples of which are shown in FIGS. 4(a), 4(b), and 4(c).

Alternative canceller arrangements may be provided. Numerous canceller circuit designs are known and may be applied, for example, a feedforward canceller using variable amplitude and phase shifters and/or a tapped-delay line may be chosen, or otherwise, an alternative means of implementing a desired transfer function. Analogue, digital, or mixed signal cancellation circuits may be used. The canceller circuit may optionally be adjustable.

The property of co-dependence between the antenna impedance matching and self-interference cancellation is notable in any canceller circuit in which the canceller transfer function is the inverse of the function which the self-interference transfer function would be if the antenna was impedance matched. This property does not depend on a specific canceller design, and a balancing impedance circuit within the canceller is not necessary to achieve this property. The canceller may preferably be designed and/or adjusted to provide a specific transfer function which provides this property, using any appropriate circuit topology.

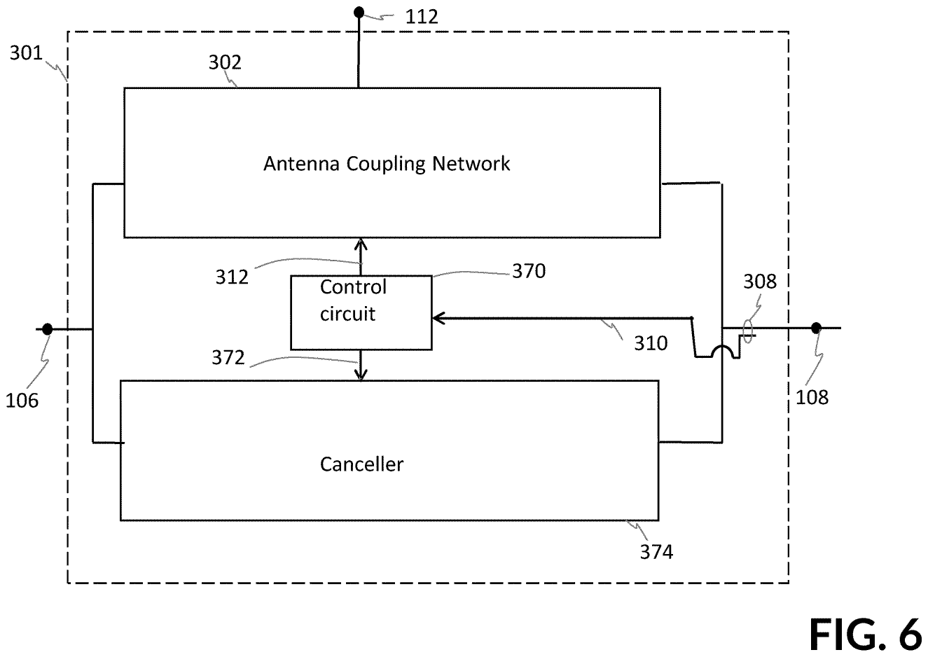

An adaptation to the second aspect shown in FIG. 3 is for the control circuit to additionally generate a control signal to the canceller, as shown in FIG. 6. Like reference numerals are used for elements which correspond to those shown in preceding figures.

A modified control circuit 370 is provided, which generates the control signals 312 to the antenna coupling network, and additionally generates canceller control signals 372 to a canceller 374.

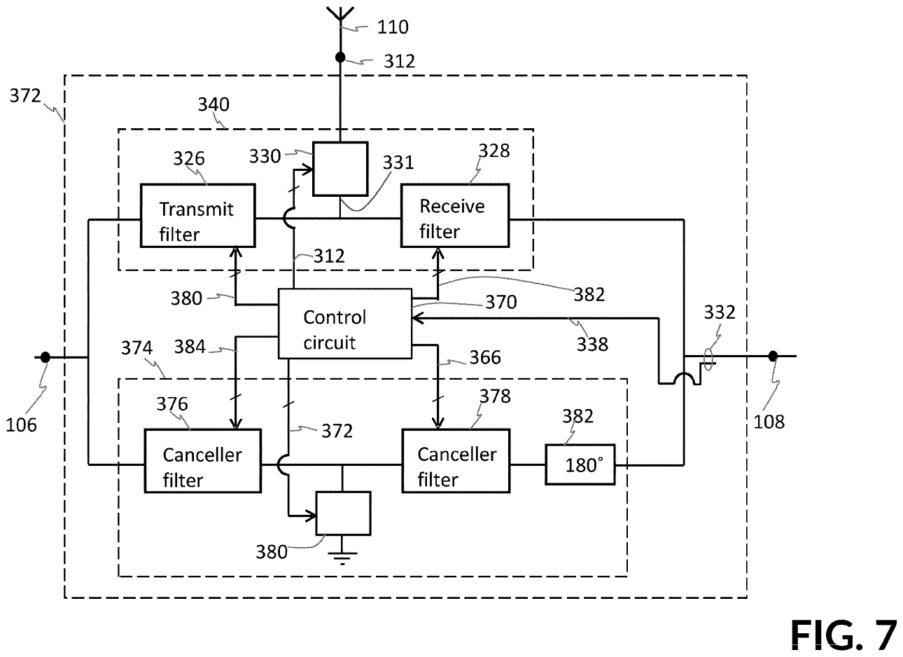

An example implementation of the arrangement of FIG. 6 is shown in FIG. 7. This example corresponds to the example of FIG. 5, with the antenna coupling network comprising the FIG. 4(b) implementation. The example arrangement of FIG. 5 is modified with the control circuit additionally generating a control signal to control the balancing load of the canceller, to adjust the impedance value of this load, as per FIG. 5.

Filters 326,328 of the antenna coupling network are variable filters and are adjusted by the control circuit 370 using control lines 380 and 382 respectively.

A canceller 374 is implemented with a first variable cancellation filter 376 having one terminal connected to the transmit port 106, a second variable cancellation filter 378 having one terminal connected to a second terminal of the first cancellation filter 376, a variable balancing impedance 380 connected between electrical ground and the first and second cancelation filters, and a 180° phase shifter 382 connected between a second terminal of the second cancellation filter and the receiver port. The variable balancing load 380 receives the control signal 372.

Canceller filters 376,378 are variable filters and are adjusted by the control circuit 370 using control lines 384 and 386 respectively.

These modifications may enable the duplexer 372 to be tuned to different frequency bands of operation. That is, the frequencies of the transmit and/or receive carrier(s) may be adjusted. The duplexer 372 may operate using frequency division duplexing, and may be tuned to select a desired FDD band.

In an example implementation, this duplexer is then further controlled as follows:
iv) Adjust the canceller 374 and antenna coupling network 340 settings to a different predetermined setting in accordance with a revised transmit and/or receiver operating frequency.

Optionally, the filters 376,378 and/or the balancing impedance 380 may be further adjusted to improve self-interference cancellation. This may occur in addition to adjustments made to the antenna impedance tuner 330.

The property of co-dependence between the antenna impedance matching and self-interference cancellation may depend upon the canceller transfer function having been set to a specific value. However relatively small adjustments made to the transfer function of the canceller 350 may be beneficial for improving cancellation, whilst still adequately maintaining the property of co-dependence in order to enable impedance matching of the antenna.

Thus in an example implementation, this duplexer is then further controlled as follows:
v) Adjust the cancellation settings in use.

If the antenna coupling network is implemented as shown in FIG. 4(a), the transmit filter 322 and/or the receive filter 324 may be adjusted in response to a self-interference signal measured at the receiver in order to improve the antenna impedance matching and/or increase the level of self-interference cancellation.

If the antenna coupling network is implemented as shown in FIG. 4(c), the canceller circuit 390 is configured to provide a canceller transfer function which is the inverse of the self-interference transfer function which would occur when a matched impedance is presented to the circulator 382 by the terminal 334 of the antenna impedance tuner 350, thereby providing for the property of co-dependence of antenna impedance matching and self-interference cancellation. Optionally, the canceller circuit 390 may also be adjustable.

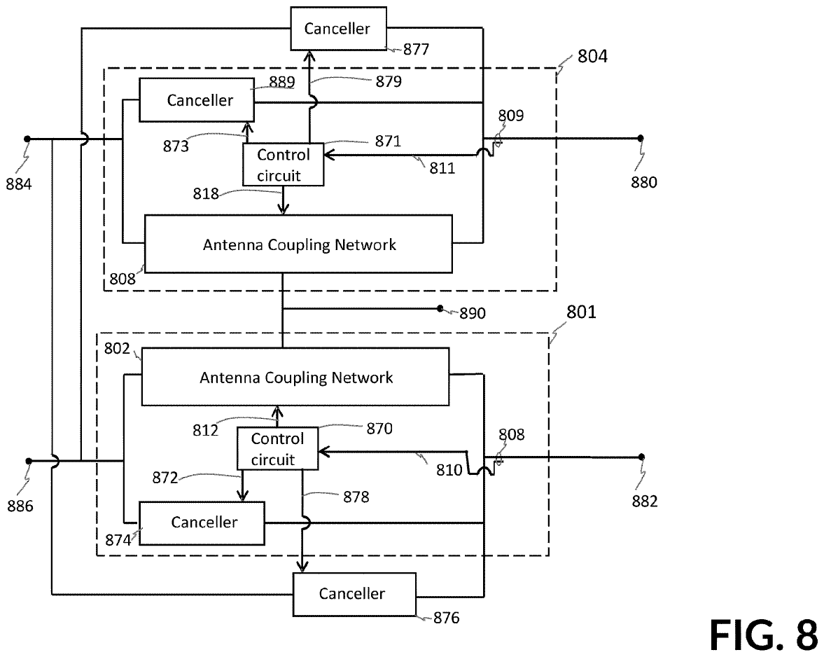

The examples above for the first and second aspects are set out in a duplexer. Described features are not limited to a duplexer, and in general apply to an n-plexer. An example is shown in FIG. 8. Like reference numerals are used to denote elements shown in earlier figures.

Transmit ports 884 and 886 receive transmit signals at different frequencies, and receiver ports 880 and 882 receive signals at different frequencies.

A first duplexer 804 includes an antenna coupling network 808 between transmit port 884, receive port 880, and antenna port 890. A canceller 889 is connected between transmit port 884 and receive port 880. A control circuit 871 receives a signal 811 measured by link 809 at the receiver, and generates a control signal on line 818 to the antenna coupling network 808, and a control signal on line 873 to canceller circuit 889.

A second duplexer 801 includes an antenna coupling network 802 between transmit port 886, receive port 882, and antenna port 890. A canceller 874 is connected between transmit port 886 and receive port 882. A control circuit 870 receives a signal 810 measured by link 808 at the receiver, and generates a control signal on line 812 to the antenna coupling network 802, and a control signal on line 872 to canceller circuit 874.

In addition a canceller 877 is provided between transmit port 886 and receiver port 880, and a canceller 876 is provided between transmit port 884 and receiver port 882.

The transmit and receive ports 886 and 882 may be operating on a first FDD band through duplexer 801. The transmit and receiver ports 884 and 880 may be operating on a second FDD band through duplexer 804. Each duplexer may be operating as any duplexer previously described.

The antenna coupling networks 808 and 802 are preferably impedance mis-matched with respect to each other, to minimise leakage of signals between them. In some embodiments, this may be achieved by using filters in the antenna coupling networks 808 and 802 tuned to the respective pairs of transmit and receive frequency bands. Canceller 877 operates to cancel leakage (via both antenna coupling networks) from transmit port 886 to receiver port 880 and canceller 876 operates to cancel leakage (via both antenna coupling networks) from transmit port 884 to receiver port 882.

A duplexer may also optionally be included to connect antenna coupling networks 808 and 802 and antenna port 890. This may provide isolation between the antenna coupling networks whilst connecting both to antenna port 890. Where this cancellation is high enough, cancellers 877 and 876 may be omitted.

FIG. 8 is exemplary, and if the principles of the first or second aspects are applied to an n-plexer arrangement, they are not limited to any details of the arrangement of FIG. 8. For example, any of the exemplary duplexer embodiments described above which include filters may be modified to use multi-resonant filters with multiple passbands, enabling each filter to pass more than one transmit or receive frequency band, which may extend a duplexer into an n-plexer for carrier aggregation.

Features of first and second aspects may be combined. There are described below other optional features and modifications which may be applied to both he first and second aspects.

In general, the level of cancellation required (e.g. 55 dB typically required for a frequency division duplex in a mobile phone) is much higher than the required antenna return loss (e.g. 15 dB return loss may typically be considered an adequate match). The antenna impedance matching is therefore less sensitive to changes in the filter control settings as compared to the cancellation. Therefore, relatively small adjustments in the control settings of a filter and/or and antenna coupling network can be applied to improve cancellation, without significantly altering the impedance matching of the antenna, in any arrangement according to the first and second aspects.

For example, cancellation of self-interference may be improved further by making additional adjustments to the transmit and receive filters 116, 118. These adjustments may be small, as it may be undesirable to make adjustments to the filter tuning settings which would result in the filter passband shifting away from a desired frequency range, e.g. the transmit or receiver frequency band(s).

Examples of adjustments that can be made to the filters 116,118 for the purpose of increasing cancellation include but are not limited to one or more of the following filter properties: centre frequency, bandwidth, amplitude response, phase response, group delay response, input impedance, output impedance, resonator coupling, quality factor. Properties of the passband(s) and/or stopband(s) of the filters may be adjusted.

Considering that the duplexer 142 has two paths containing configurable circuits which are preferably providing two transfer functions in anti-phase, the transmit filter and/or receive filter can be considered to behave as a canceller circuit, and various algorithms known for controlling canceller circuits are applicable to controlling the transmit filter and/or the receive filter to increase cancellation (where the transmit and receive filters are provided in any arrangement according to the first and second aspects). Desirably the passband(s) and stopbands(s) of these filter(s) remain in the same or similar frequency ranges which may be a transmit and/or receive bands or bands. This may be provided for by limiting the amount by which the control settings of these filters are allowed to deviate from a set of preferred filter settings selected for operation in a particular frequency band or bands.

The purpose of the adjustment is to provide a self-interference transfer function which can be approximated (in anti-phase) by the canceller circuit 120 with a smaller error over a particular frequency band or bands, thereby providing a higher level of cancellation in combination with the canceller circuit.

Adjusting the transmit and/or receive filters in addition to adjusting the canceller circuit may provide better anti-phase correspondence between the self-interference transfer function and the transfer function of the canceller over a bandwidth of interest.

The filters may be simultaneously adjusted to improve impedance matching with the antenna and to modify the self-interference transfer function in a manner which is beneficial to the level of cancellation which can be achieved.

Control of the transmit filter and/or receive filter (where provided in accordance with any of the first and second aspects) to improve cancellation of self-interference in dependence on one or more inputs of the control circuit may be performed according to known algorithms for self-interference cancellation, such as gradient-based iterative optimisation. Various known algorithms may be applicable. Such algorithms may be applied by the control circuit 114.

Control of the antenna impedance tuner 330 in response to a signal measured at the receive port may be performed according to known algorithms for self-interference cancellation, such as gradient-based iterative optimisation. Various known algorithms may be applicable. Such algorithms may be applied by the control circuit 306 or control circuit 370.

Control of the canceller circuit in dependence on one or more inputs of the control circuit may be performed according to known algorithms self-interference cancellation, such as gradient-based iterative optimisation. Various known algorithms may be applicable. Such algorithms may be applied by the control circuit.

Control of the transmit filter 116 and/or receive filter 118 to improve impedance matching at the antenna port in dependence on one or more inputs of the control circuit 124 may be performed by adjusting components at the output and/or input of the transmit and/or receiver filters respectively. Various impedance tuning algorithms are known and may be applied. Such algorithms may be applied by the control circuit 114. The frequencies of the passband(s) and stopbands(s) of the filter(s) are desirably unmodified.

The tuneable transmit and receiver filters 116,118 are typically used, as noted above, for selecting between a plurality of operating frequency bands of a wireless device, and thus are typically tuned to select a given frequency band.

Any controllable feature may be controlled by computer program, and any process or method may be implemented as a computer program. Any computer program may be provided on a transient or intransient medium.

Various examples and embodiments have been set out as circuits or apparatus. The invention is not limited to circuits or apparatus. The invention may be embodied by methods or processes. Methods or processes may be implemented, at least in part, utilising computer processing techniques. A computer program code may be provided which, when executed on a processor, may perform any method or process, at least in part. A computer program product may be provided on which such computer program code is stored.

Various examples and embodiments have been set out to illustrate invention. Aspects of examples and embodiments may be combined.

The invention has been described by way of reference to various embodiments and implementations. The invention is not limited to the specifics of any example. The scope of protection afforded by the invention is defined by the appended claims.

1. A circuit for transmitting a transmit signal at a transmit frequency and for receiving a signal at a receive frequency, using a common antenna, comprising:
a transmit filter connected between a transmit port and an antenna port;
a receive filter connected between a receive port and the antenna port;
a cancellation circuit connected between the transmit port and the receive port to cancel self-interference between the transmit and receive ports; and
a control circuit for modifying the transmit and/or receive filters to improve impedance matching between the antenna port and the transmit filter output and/or the receive port filter input.

2. The circuit of claim 1 in which the antenna port is for connection to the common antenna.

3. The circuit of claim 1 or claim 2 in which the transmit port is for connection to the output of a power amplifier.

4. The circuit of any one of claims 1 to 3 in which the receive port is for connection to the input of a low noise amplifier.

5. The circuit of any one of claims 1 to 4 in which the control circuit is connected to measure a signal at the antenna port, and modify the transmit filter and/or the receive filter to improve the impedance matching in dependence on the signal measured at the antenna port.

6. The circuit of any one of claims 1 to 5 in which the control circuit is connected to measure a signal at the receive port, and modify the transmit filter and/or the receive filter to improve impedance matching in dependence on the signal measured at the receiver port.

7. The circuit of any one of claims 1 to 6 in which the control circuit is further configured to modify the cancellation circuit to improve self-interference cancellation between the transmit and receive ports.

8. The circuit of claim 7 wherein the control circuit is configured to modify the cancellation circuit in dependence on a signal measured at the antenna port.

9. The circuit of claim 7 or claim 8 in which the control circuit is configured to modify the cancellation circuit in dependence on a signal measured at the receive port.

10. The circuit of any one of claims 7 to 9 wherein the control circuit is further configured to modify the transmit and/or receive filter to further improve self-interference cancellation between the transmit and receive ports.

11. The circuit of any ones of claims 6 to 10 wherein the control circuit is configured to measure only the unwanted power at the receive port.

12. The circuit of claim 11 wherein the unwanted power is the power due to self-interference between the transmit and receive ports.

13. The circuit of claims 6 to 10 further configured in dependence on the measured signal at the receive port to control:
i) the transmit and/or receive filters to improve impedance matching between the antenna port and each of the transmit and/or receive ports; and
ii) the cancellation circuit to improve self-interference cancellation between the transmit and receive ports.

14. The circuit according to claim 13 wherein the control circuit is further configured in dependence on that measured power at the receive port to control:
iii) the transmit and/or receive filters to improve self-interference cancellation between the transmit and receive ports.

15. A method for transmitting a signal at a transmit frequency and for receiving a signal at a receive frequency, using a common antenna, the method comprising:
filtering a transmit signal received at a transmit port for delivery to an antenna port;
filtering a receive signal received at the antenna port for delivery to a receive port;
applying cancellation to cancel self-interference between the transmit and receive ports; and
modifying the filtering of the transmit and/or receive signal to improve impedance matching with the antenna port.

16. The method claim 154 further comprising measuring a signal at the antenna port, and modifying the transmit and/or the receive filtering to improve the impedance matching in dependence on the signal measured at the antenna port.

17. The method of claim 15 or claim 16 in further comprising measuring a signal at a the receive port, and modifying the transmit and/or the receive filtering to improve impedance matching in dependence on the signal measured at the receiver port.

18. The method of any one of claim 15 to 17 further comprising modifying the cancellation circuit to improve self-interference cancellation between the transmit and receive ports.

19. A circuit for transmitting and receiving using a common antenna, comprising:
an adjustable antenna coupling network connecting a transmitter, an antenna, and a receiver;
a cancellation circuit connected between the transmitter and the receiver, configured to at least partially cancel self-interference; and
a controller configured to modify the antenna coupling network in dependence on a self-interference signal measured at the receiver to improve impedance matching of the antenna.

20. The circuit of claim 19 further comprising a circuit to measure the self-interference signal at the receiver.

21. The circuit of claim 20 wherein the self-interference signal is measured at a receive port.

22. The circuit of claim 20 or 21 wherein the self-interference signal is measured at an input of a low noise amplifier connected to a receive port.

23. The circuit of any one of claims 19 to 22 wherein the cancellation circuit is an adjustable cancellation circuit.

24. The circuit of claim 23 wherein the adjustable cancellation circuit is adjusted to increase the level of self-interference cancellation.

25. The circuit of any one of claims 19 to 24 wherein the antenna coupling network includes an antenna impedance tuner connected to the antenna, the controller being configured to modify the antenna impedance tuner to match antenna impedance.

26. The circuit of claim 25 wherein the antenna coupling network further includes a transmit filter and/or a receive filter, the antenna impedance tuner matching the antenna impedance to the output of the transmit filter and/or the input of the receive filter.

27. The circuit of claim 24 wherein the antenna coupling network further comprises a circulator connected between the transmitter, the receiver, and the antenna, the controller being configured to modify the antenna impedance tuner to match the antenna impedance to the circulator impedance at the transmit and receive frequencies.

28. The circuit of any one of claims 26 or 27 wherein the antenna impedance tuner is connected between the antenna and the transmit and/or receive filters.

29. The circuit of any one of claims 25 to 27 wherein the antenna impedance tuner is connected between the antenna port and electrical ground.

30. The circuit of any one of claims 25 to 29 wherein the controller is further configured to adjust the output impedance of the transmit filter and/or the input impedance of the receive filter to match the antenna impedance.

31. The circuit according to any one of claims 19 to 30 in which the cancellation circuit includes a balancing load, and the impedance presented by the antenna is modified to match the impedance presented by the balancing load.

32. A method for transmitting and receiving using a common antenna, comprising:
a connecting a transmit port, an antenna port, and a receive port;
at least partially cancel received self-interference between the transmitter and the receiver;
measuring a self-interference signal at the receiver; and
modifying the antenna coupling network to improve impedance matching of the antenna in dependence on the measured self-interference signal.
